(19) United States
(12) Patent Application Publication
(10) Pub. No.: US 2015/0160102 A1
(43) Pub. Date: Jun. 11, 2015

(54) SYSTEM AND METHOD FOR SAMPLING OF FLUID

(71) Applicant: Caterpillar Inc., Peoria, IL (US)

(72) Inventors: Andrew M. Denis, Peoria, IL (US); Mirza P. Baig, LaGrange, GA (US); Sachin S. Deshmukh, Peoria, IL (US); Eric P. Spaeth, Pekin, IL (US)

(73) Assignee: Caterpillar Inc., Peoria, IL (US)

(21) Appl. No.: 14/102,964

(22) Filed: Dec. 11, 2013

(51) Int. Cl. G01N 1/22; F01N 3/20

(52) U.S. Cl. CPC G01N 1/22; F01N 3/2066

(57) ABSTRACT

A system including a sampling flute is provided. The sampling flute defines a conduit therein. The sampling flute includes a plurality of holes configured for allowing passage of an exhaust gas flow therethrough. The system also includes a hood provided on the sampling flute. The hood is configured to enclose a nitrogen oxide sensor therein. The hood includes an inlet in fluid communication with the sampling flute. The hood also includes an outlet positioned opposed to the inlet. The hood is configured to cause the exhaust gas flow to impact a side of the nitrogen oxide sensor.

### TECHNICAL FIELD

The present disclosure relates to a system and method for sampling of a fluid, and more specifically to a sampling flute for sampling of an exhaust gas flow.

### BACKGROUND

A nitrogen oxide sensor (NOx sensor) may be positioned at various locations in an engine system, in order to measure a concentration of nitrogen oxide in exhaust gas flowing through the system. For example, the NOx sensor may be present downstream of an outlet of a Selective Catalytic Reduction (SCR) catalyst with respect to a direction of flow of the exhaust gas.

A reading provided by the NOx sensor is based on a portion of the exhaust gas flowing thereover. However, in some situations, the NOx sensor may contact with a relatively small portion of the exhaust gas flow due to its position within an exhaust conduit of the exhaust system. Known designs include providing a sampling element within an exhaust outlet in order to direct a portion of the exhaust gas flow over the NOx sensor, such that the directed exhaust gas flow may contact with a tip of the NOx sensor. In such situations, the readings provided by the NOx sensor may still be inaccurate since the exhaust gas flow may contact a relatively small surface area of the NOx sensor. Further, the NOx sensor present within the exhaust outlet may be subject to damage due to entry of water or debris into the exhaust outlet.

U.S. Pat. No. 6,843,104 discloses a system for measuring gaseous constituents of a flowing gas mixture. The system includes a gas flow control device. The system also includes at least one sensor which is in use in contact with the flowing gas mixture. The system further includes at least one mixing device inserted in a flow of the gas mixture. The mixing device includes a first end at which the at least one sensor is provided. The mixing device also includes a second end adapted to rest against a wall of a pipe through which the gas mixture can flow, and in use homogenizes the gas mixture to mixed gas before it is detected by the sensor.

### SUMMARY OF THE DISCLOSURE

In one aspect of the present disclosure, a system including a sampling flute is provided. The sampling flute defines a conduit therein. The sampling flute includes a plurality of holes configured for allowing passage of an exhaust gas flow therethrough. The system also includes a hood provided on the sampling flute. The hood is configured to enclose a nitrogen oxide sensor therein. The hood includes an inlet in fluid communication with the sampling flute. The hood also includes an outlet positioned opposed to the inlet. The hood is configured to cause the exhaust gas flow to impact a side of the nitrogen oxide sensor.

In another aspect of the present disclosure, an exhaust system is provided. The exhaust system includes an exhaust stack. The exhaust system includes an exhaust duct of a Selective Catalytic Reduction (SCR) catalyst coupled to the exhaust stack. The exhaust duct is provided downstream of the SCR catalyst with respect to an exhaust gas flow. The exhaust system includes a nitrogen oxide sensor disposed within the exhaust duct. The exhaust system also includes a sampling flute disposed within the exhaust duct. The sampling flute defines a conduit therein. The sampling flute includes a plurality of holes configured for allowing passage of the exhaust gas flow therethrough. The exhaust system further includes a hood provided on the sampling flute. The hood is configured to enclose the nitrogen oxide sensor therein. The hood includes an inlet in fluid communication with the sampling flute. The hood also includes an outlet positioned opposed to the inlet. The hood is configured to cause the exhaust gas flow to impact a side of the nitrogen oxide sensor.

In yet another aspect of the present disclosure, a method of sampling an exhaust gas flow from across an exhaust duct is provided. The method includes providing a passage for an exhaust gas flow within the exhaust duct. The method includes channeling at least a portion of the exhaust gas flowing through the passage into a conduit. The conduit culminates in a hood. The method also includes directing the channelized exhaust gas flow across the hood. The method further includes passing the exhaust gas flow outside the hood.

Other features and aspects of this disclosure will be apparent from the following description and the accompanying drawings.

### BRIEF DESCRIPTION OF THE DRAWINGS

FIG. 1 is an exemplary exhaust system according to one embodiment of the present disclosure;

FIG. 2 is a side view of an exhaust duct showing a sampling flute placed therein;

FIGS. 3 to 5 are perspective views of the exhaust duct and the sampling flute showing different assemblies of a hood associated with the exhaust duct, according to various embodiments of the present disclosure; and

FIG. 6 is a flowchart of an exemplary method of sampling of the exhaust gas flow.

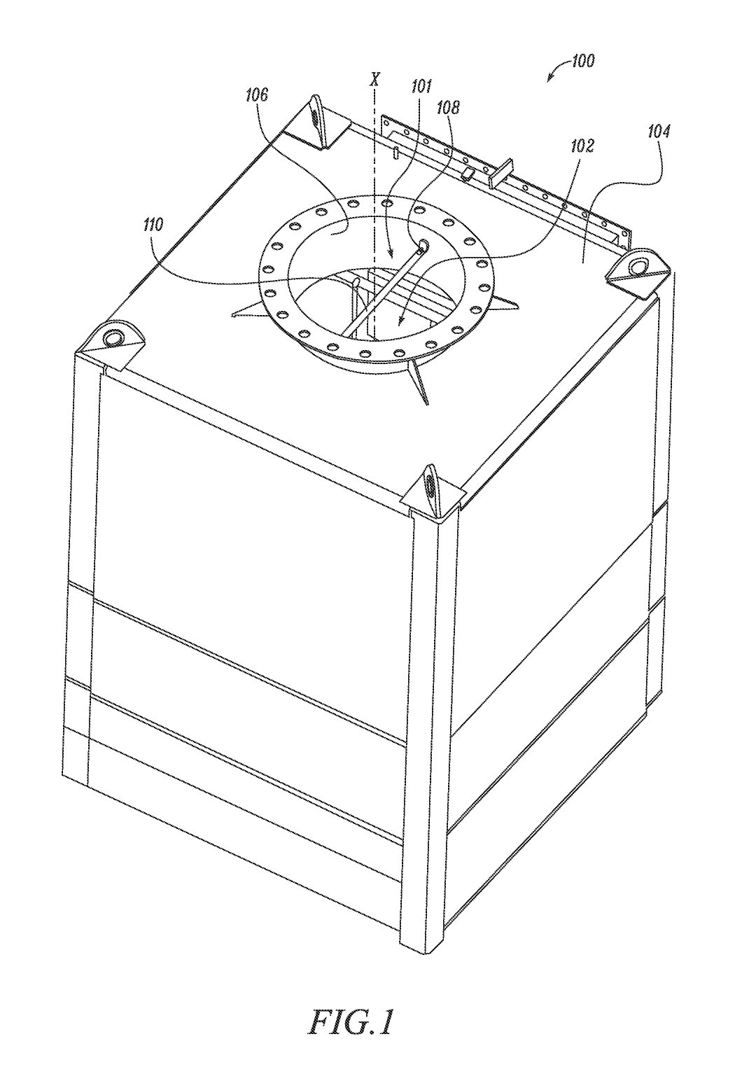

### DETAILED DESCRIPTION

Wherever possible, the same reference numbers will be used throughout the drawings to refer to the same or the like parts. Referring to FIG. 1, an exemplary exhaust system 100 of an engine (not shown) is illustrated. The exhaust system 100 includes an outlet 101. This outlet 101 is located downstream of a Selective Catalytic Reduction (SCR) catalyst of an aftertreatment system 102 of the engine, with respect to a direction of flow of exhaust gas in the system. The aftertreatment system 102 is enclosed within a housing 104 in the accompanying figures. The aftertreatment system 102 is configured to introduce a reductant into the exhaust gas flow of the engine. The exhaust gas flow may contain one or more constituents, such as, carbon monoxide (CO), sulfur dioxide (SO2), nitrogen oxides (NOx) and other similar compositions in a gaseous state. In one embodiment, the aftertreatment system 102 may introduce the reductant to reduce and/or convert an amount of NOx present in the exhaust gas flow into other compounds using one or more chemical reactions and/or processes.

The aftertreatment system 102 may include a number of components therein. An inlet duct (not shown) of the aftertreatment system 102 may be fluidly coupled to an exhaust manifold (not shown) of the engine. The inlet duct may be configured to receive the exhaust gas flow from the engine. The aftertreatment system 102 may include one or more SCR catalysts (not shown) and/or a reductant injector (not shown) configured to introduce the reductant into the exhaust gas flow. The reductant, and/or decomposition byproducts thereof, disposed on the SCR catalysts may react with NOx present in the exhaust gas flow to form water (H₂O) and diatomic nitrogen (N₂).

The exhaust duct 106 is in fluid communication with an outlet (not shown) of the SCR catalyst. The exhaust duct 106 is configured to exit the exhaust gas flow out of the housing 104. In one embodiment, the exhaust duct 106 may be fluidly coupled to an exhaust stack (not shown). The exhaust stack may be open to atmosphere. In another embodiment, the exhaust duct 106 may be further fluidly coupled to another module (not shown) of the aftertreatment system 102. The exhaust duct 106 illustrated in the accompanying figures has a hollow cylindrical configuration defining a longitudinal axis X-X. It should be noted by one of ordinary skill in the art that the exhaust duct 106 may have any other configuration, such as, a rectangular configuration, an elliptical configuration and other similar configurations.

The exhaust duct 106 may include a NOx sensor 108 disposed therein. In one embodiment, the NOx sensor 108 is located on a surface of the exhaust duct 106. For example, the NOx sensor 108 may be disposed in a manner such that the NOx sensor 108 protrudes into the exhaust duct 106 substantially perpendicular to the longitudinal axis X-X. The NOx sensor 108 may be affixed to the exhaust duct 106 by any fastening method known in the art including, but not limited to, bolting, screw fitting, adhesion and other similar fastening means as would be apparent to one of ordinary skill in the art. The NOx sensor 108 may be configured to measure a concentration of NOx in the exhaust gas flow.

The exhaust duct 106 includes a sampling flute 110 provided in cooperation with the NOx sensor 108. The sampling flute 110 is disposed within the exhaust duct 106 substantially perpendicular to the longitudinal axis X-X of the exhaust duct 106. More specifically, the sampling flute 110 is provided within the exhaust duct 106. The sampling flute 110 may extend across at least a portion of a width of the exhaust duct 106. In the illustrated embodiment, the sampling flute 110 is provided extending diametrically within the exhaust duct 106. The sampling flute 110 is configured to sample the exhaust gas flow by channeling a portion of the exhaust gas flow towards the NOx sensor 108. The sampling flute 110 is also configured for increasing fills per measurement of the sampled exhaust gas flow. The increased fills per measurement increases the amount of exhaust gas flow sampled by the sampling flute 110. Additionally, the sampling flute 110 may also homogenize the exhaust gas flowing towards the NOx sensor 108.

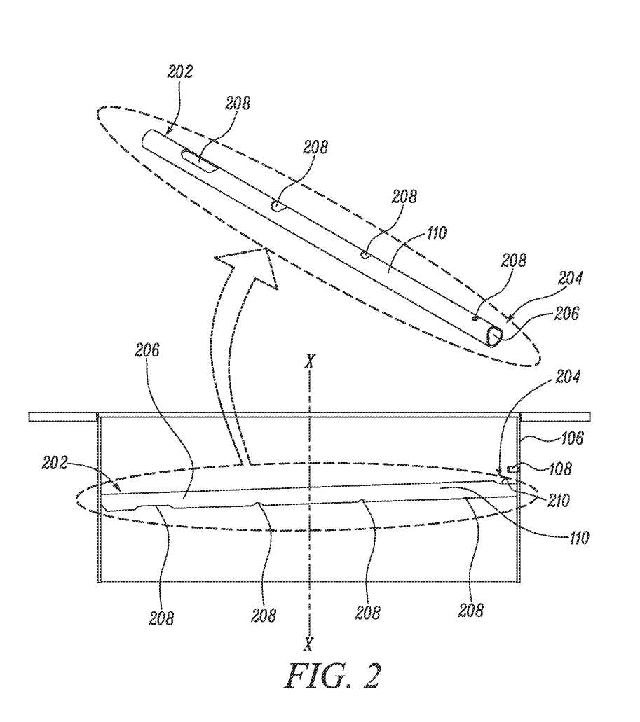

Referring to FIG. 2, a side view of the exhaust duct 106 including the sampling flute 110 is illustrated. FIG. 2 also includes an enlarged view of the sampling flute 110 for the purpose of clarity. The sampling flute 110 has a first end 202 and a second end 204. The sampling flute 110 has an elongated, hollow, cylindrical configuration defining a conduit 206.

The sampling flute 110 includes a plurality of holes 208 opening into the conduit 206. The plurality of holes 208 is provided collinearly between the first and second ends 202, 204 of the sampling flute 110 in a spaced apart arrangement with respect to each other. The plurality of holes 208 is configured to receive the portion of the exhaust gas flow into the conduit 206. In one embodiment, the plurality of holes 208 may have a generally similar shape and size. Alternatively, the plurality of holes 208 may vary in shape and dimension.

In the illustrated embodiment, the plurality of holes 208 includes four holes 208 provided on the sampling flute 110. The shape of the hole 208 adjacent the first end 202 has a substantially slot like configuration. The shape of the remaining plurality of holes 208 is substantially circular. A diameter of each of the remaining plurality of holes 208 reduces gradually from the first end 202 towards the second end 204 of the sampling flute 110. It will be apparent to one of ordinary skill in the art that the shape, number and dimensions of each of the plurality of holes 208 provided on the sampling flute 110 may vary as per system design and requirements. The shape, number and dimensions of the plurality of holes 208 is configured to prevent exiting of the exhaust gas received into the conduit 206 from flowing therethrough and to gather equal amounts of the exhaust gas flow from different positions across the exhaust duct 106.

Further, in one embodiment, the sampling flute 110 may be positioned within the exhaust duct 106 in such a manner that the sampling flute 110 is substantially inclined with respect to the longitudinal axis X-X. This inclination of the sampling flute 110 allows for debris and/or water that may have entered into the exhaust duct 106 to slide down the sampling flute 110, thereby protecting the NOx sensor 108 from prolonged exposure to debris and/or water.

The sampling flute 110 also includes an exhaust outlet 210 provided in cooperation with the NOx sensor 108. In the illustrated embodiment, the exhaust outlet 210 is provided on the second end 204 of the sampling flute 110 and on a side of the sampling flute 110 which opposes the side that contains the plurality of holes 208. The exhaust outlet 210 is configured to allow the received exhaust gas that flows in the conduit 206 to exit out of the sampling flute 110 and towards the NOx sensor 108.

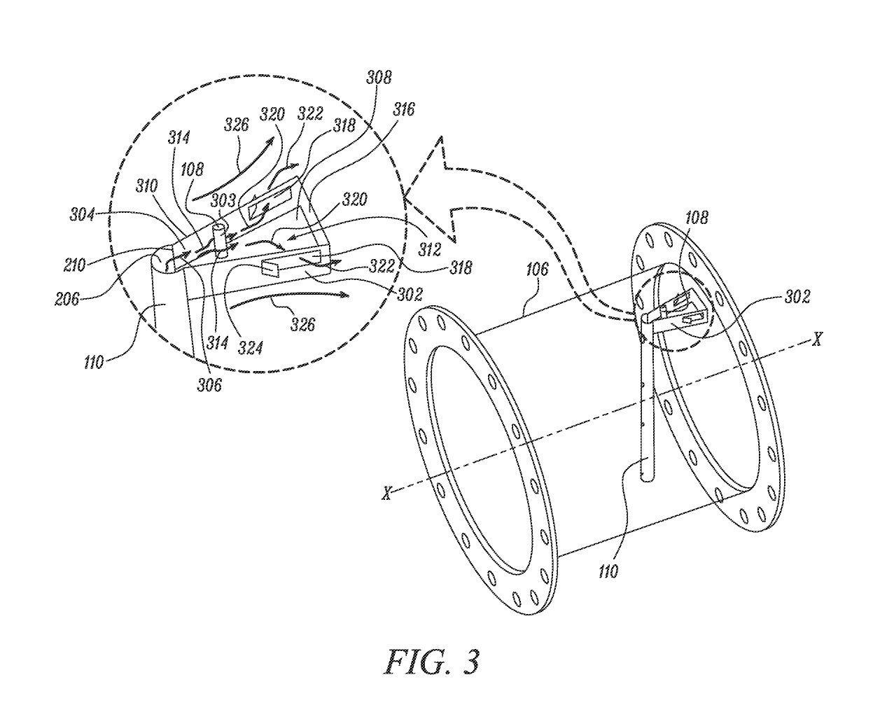

FIG. 3 illustrates an enlarged view of a first exemplary configuration of a hood 302 attached to the sampling flute 110. The hood 302 may be provided on the second end 204 of the sampling flute 110, such that the hood 302 extends from, and faces away from, the side of the sampling flute 110 that opposes the side containing the plurality of holes 208. In one embodiment, the hood 302 may be provided in contact with an inner surface of the exhaust duct 106. The sampling flute 110 and the hood 302 may be positioned towards an end of the exhaust duct 106 further away from the outlet of the SCR catalyst.

As shown, the hood 302 may be disposed on the sampling flute 110 in a manner such that the hood 302 extends in a direction substantially along the longitudinal axis X-X defined by the exhaust duct 106. The hood 302 is configured to enclose the NOx sensor 108 therein. The hood 302 may also be configured to cause the exhaust gas flow received in the conduit 206 to impact a longitudinal side 303 of the NOx sensor 108. Additionally, the hood 302 may protect the NOx sensor 108 from water and/or debris which may enter into the exhaust duct 106. The structure and construction of the hood 302 will now be described in detail.

The hood 302 includes an inlet 304. The inlet 304 is provided in fluid communication with the exhaust outlet 210 of the sampling flute 110. The inlet 304 is configured to receive the exhaust gas flow from the sampling flute 110 as shown by an arrow 306. The hood 302 includes a base plate 308 and a pair of side walls 310 extending from the inlet 304. The pair of side walls 310 may be provided substantially perpendicular to the base plate 308. The pair of side walls 310 in cooperation with the base plate 308 defines a chamber 312 within the hood 302 for passage of the exhaust gas flow therethrough. The chamber 312 is configured to allow expansion of the exhaust gas flow received from the conduit 206. Further, the positioning of the pair of side walls 310 on either side of the NOx sensor 108 may cause the exhaust gas flow to impact the longitudinal side 303 of the NOx sensor 108, as shown by an arrow 314.

In one embodiment, the hood 302 also includes an end plate 316 fixedly affixed to the pair of side walls 310 and the base plate 308. The end plate 316 may be positioned opposing the inlet 304 of the hood 302. In one embodiment, the end plate 316 may be provided substantially perpendicular to the base plate 308. The end plate 316 in cooperation with the base plate 308 and the pair of side walls 310 may be configured to protect the NOx sensor 108 disposed within the hood 302 from water and/or other debris which may otherwise contact the NOx sensor 108 and foul or damage the NOx sensor 108. The end plate 316 is also configured to deflect the exhaust gas flow received in the chamber 312 towards an outlet 318 of the hood 302 as shown by an arrow 320.

The outlet 318 may be provided on at least one of the base plate 308, the pair of side walls 310 and/or the end plate 316. More specifically, the outlet 318 is positioned on the hood 302 to allow flow from the inlet 304 to exit the hood 302. In the illustrated embodiment, the outlet 318 is provided on each of the pair of side walls 310. The outlet 318 is configured to exit the exhaust gas flow out of the hood 302 as shown by an arrow 322.

In the illustrated embodiment, as shown in FIG. 3, the hood 302 may also include a fairing 324 affixed on one end of the outlet 318. More specifically, the fairing 324 is provided extending away from the hood 302 at that end of the outlet 318 which lies in the direction of the flow of the exhaust gas. The fairing 324 is configured to deflect at least a portion of the exhaust gas flowing within the exhaust duct 106 and over the sampling flute 110 and the hood 302, away from the outlet 318 of the hood 302. This deflection of the exhaust gas flow away from the hood 302 may reduce or eliminate any increased pressure in the hood 302 due to stagnating flow. The stagnating flow may reduce a flow rate of the exhaust gas flow through the sampling flute 110 and/or may create a low pressure recirculation of the exhaust gas flow at the outlet 318 of the hood 302 which may increase the flow rate of the exhaust gas flow through the sampling flute 110.

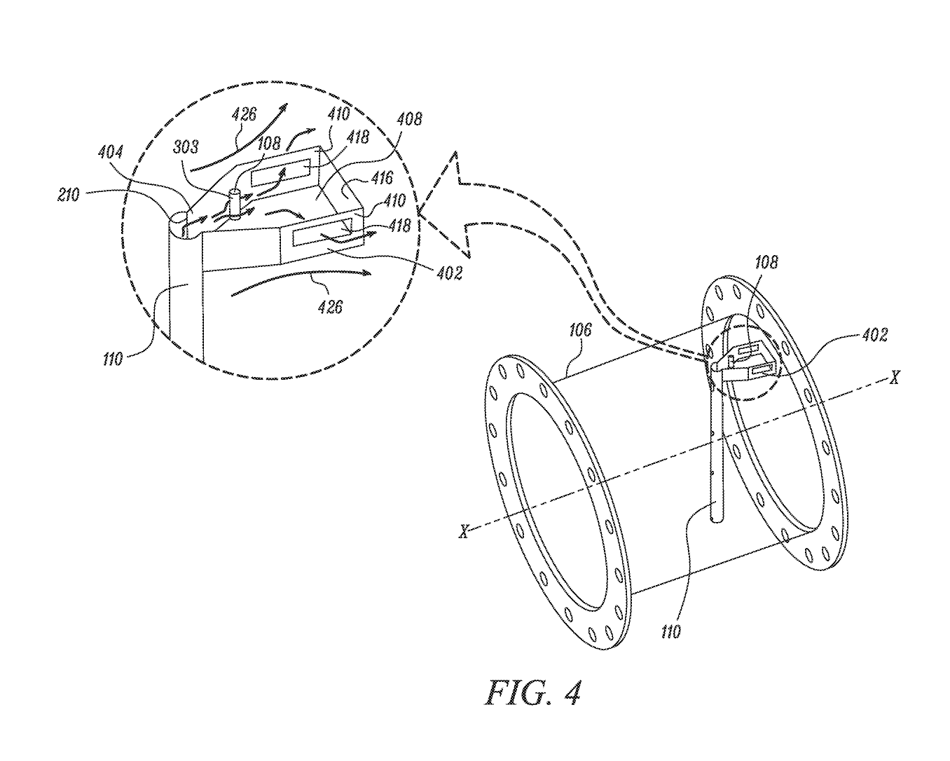

Referring to FIG. 4, a second exemplary configuration of the hood 402 is illustrated. In the second configuration of the hood 402, the inlet 404, the base plate 408, the end plate 416 and the outlet 418 is similar to the first configuration of the hood 402. The pair of side walls 410 is provided partly inclined and partly parallel to each other. More specifically, the pair of side walls 410 is inclined to each other at an upstream end of the pair of side walls 410 with respect to the exhaust gas flow. At a downstream end with respect to the exhaust gas flow, the pair of side walls 410 is parallel to each other. The outlet 418 is provided on the downstream end of the pair of side walls 410 parallel to each other. This configuration of the pair of side walls 410 causes deflection of the exhaust gas flow by the partly inclined portion of the pair of side walls 410, flowing in the exhaust duct 106 and over the sampling flute 110 and the hood 402, away from the outlet 418 of the hood 402 as shown by the arrow 426, to prevent a reduction of and/or to provide an increase in the exhaust gas flow rate through the sampling flute 110.

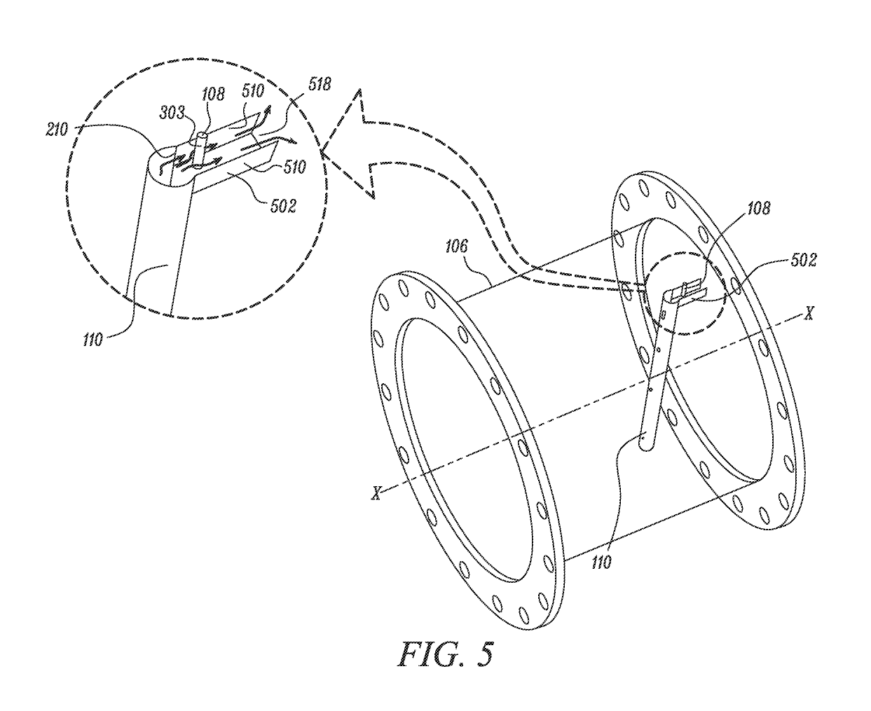

Referring to FIG. 5, a third exemplary configuration of the hood 502 is illustrated. The hood 502 includes the pair of side walls 510 provided substantially parallel to each other. The outlet 518 allows the exhaust gas flow to exit out of the hood 502. In another embodiment, the hood 502 may include the end plate (not shown). In such a situation the outlet 518 may be provided on the end plate. In yet another embodiment, wherein the hood 502 includes the end plate, the outlet 518 may be provided on the pair of side walls 510. In such a situation, the fairing 324 (as shown in FIG. 3) may be provided on the pair of side walls 510 in order to prevent the reduction of and/or to provide the increase in the exhaust gas flow rate through the sampling flute 110.

The exemplary embodiments of hoods 302, 402, 502 may be formed of any polymer or metal known in the art by any known manufacturing process such as molding, sheet metal working process such as stamping and so on, respectively. The hoods 302, 402, 502 may be affixed to the sampling flute 110 and/or the exhaust duct 106 by any known fastening method such as welding, soldering, brazing, bolting and so on. In one embodiment, the hood 302, 402, 502 may be integral to the sampling flute 110. It should be noted that the configurations of the hood 302, 402, 502 and location of the sampling flute 110 and/or the positioning of the hood 302, 402, 502 within the exhaust duct 106 may vary as per system design and requirements.

### INDUSTRIAL APPLICABILITY

During operation of the engine, the exhaust gas flowing in the exhaust duct may contain water vapor. The water vapor may condense on the inner surface of the exhaust duct. In addition to the condensed water vapor, rainwater may also enter the exhaust duct and flow along the inner surface of the exhaust duct. The condensed and/or the entrained water may contact with the NOx sensor disposed within the exhaust duct and may further cause fouling of the NOx sensor. Further, the exhaust gas flow may contain unwanted debris which may contact and cause physical damage to the NOx sensor.

Additionally, in some situations the exhaust gas flowing in the exhaust duct may contact a relatively small surface area or a tip of the NOx sensor. A reduced amount of surface contact may provide undervalued reading of the concentration of the constituents present in the exhaust gas flow, which in turn may lead to inefficient sensing by the NOx sensor.

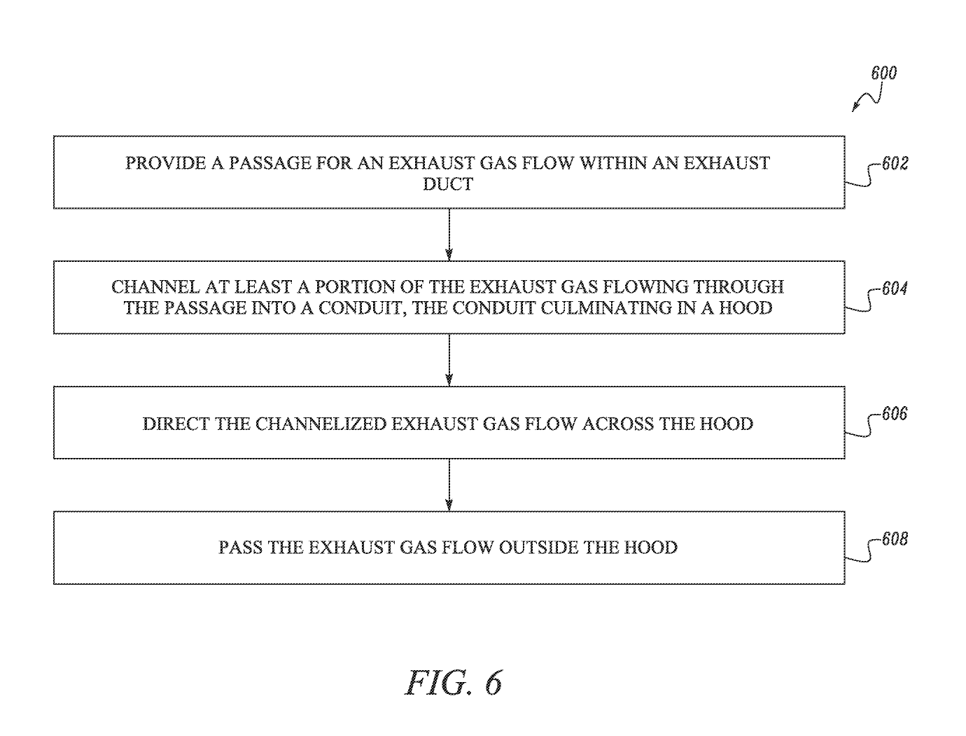

The present disclosure provides the sampling flute 110 and the hood 302, 402, 502 for sampling of the exhaust gas flowing in the exhaust duct 106. Referring to FIG. 6, a flowchart of an exemplary method 600 of sampling the exhaust gas flow from across the exhaust duct 106 is illustrated. During operation of the engine, the exhaust gas flow may be received into the exhaust duct 106. At step 602, the exhaust duct 106 provides a passage for the exhaust gas to flow out into the atmosphere or any other component associated with the exhaust system 100 as the case may be. At step 604, the portion of the exhaust gas flowing in the exhaust duct 106 is channelized through the plurality of holes 208 provided on the sampling flute 110 into the conduit 206 of the sampling flute 110. In the illustrated embodiment, the conduit 206 culminates in the hood 302, 402, 502 at the second end 204 of the sampling flute 110.

At step 606, the channelized exhaust gas flow received into the conduit 206 is directed towards and into the hood 302, 402, 502. As the exhaust gas flows across the chamber 312 of the hood 302, 402, 502, the exhaust gas flow may impact the longitudinal side 303 of the NOx sensor 108. The design and construction of the hood 302, 402, 502 allows for improved contact between the NOx sensor 108 and the exhaust gas flow. The side walls 310, 410, 510 may deflect the exhaust gas flow entering into the hood 302, 402, 502 in such a manner that the exhaust gas flow may contact the longitudinal side 303 of the NOx sensor 108.

At step 608, the exhaust gas flow is passed outside the hood 302, 402, 502 from the outlet 318, 418, 518 after impacting the NOx sensor 108. During operation of the system, the hood 302, 402, 502 may also deflect and thereby prevent water and/or the debris from contacting and fouling and/or damaging the NOx sensor 108. In one embodiment, the fairing 324 provided on the hood 302 may deflect at least the portion of the exhaust gas flowing through the exhaust duct 106 away from the hood 302 in order to prevent the reduction of and/or to provide the increase in the exhaust gas flow rate through the sampling flute 110. Additionally, the sampling flute 110 and the arrangement of the hood 302, 402, 502 may also provide an increase in spatial velocity of the exhaust gas flowing therethrough.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system comprising:
a sampling flute defining a conduit therein, the sampling flute including a plurality of holes configured to allow passage of an exhaust gas flow therethrough; and
a hood provided on the sampling flute, the hood configured to enclose a nitrogen oxide sensor therein, the hood comprising:
an inlet in fluid communication with the sampling flute; and
an outlet in fluid communication with the inlet,
wherein the hood is configured to cause the exhaust gas flow to impact a side of the nitrogen oxide sensor.

2. The system of claim 1, wherein the hood further comprises:
a base plate extending from the inlet; and
a pair of side walls extending from the inlet and provided in cooperation with the base plate, the pair of side walls defining a chamber within the hood for the passage of the exhaust gas flow therethrough.

3. The system of claim 2, wherein the hood further includes:
an end plate attached to the base plate and the pair of side walls, the end plate configured to protect the nitrogen oxide sensor disposed therein from at least one of debris and water from falling thereon.

4. The system of claim 3, wherein the outlet is positioned on at least one of the base plate, the pair of side walls and the end plate.

5. The system of claim 1 further comprising:
a fairing extending away from one end of the outlet, the fairing configured to deflect a portion of the exhaust gas flowing over the sampling flute and the hood away from the outlet.

6. The system of claim 1, wherein the hood is attached to one end of the sampling flute.

7. The system of claim 1, wherein the hood is disposed on a side of the sampling flute opposing a side containing the plurality of holes.

8. The system of claim 1, wherein the hood is attached to an inner surface of an exhaust duct situated downstream of a Selective Catalytic Reduction (SCR) catalyst with respect to the exhaust gas flow.

9. An exhaust system comprising:
an exhaust stack;
an exhaust duct of a Selective Catalytic Reduction (SCR) catalyst coupled to the exhaust stack, the exhaust duct provided downstream of the SCR catalyst with respect to an exhaust gas flow;
a nitrogen oxide sensor disposed within the exhaust duct;
a sampling flute disposed within the exhaust duct, the sampling flute defining a conduit therein, wherein the sampling flute comprises a plurality of holes configured for allowing passage of the exhaust gas flow therethrough; and
a hood provided on the sampling flute, the hood configured to enclose the nitrogen oxide sensor therein, the hood comprising:
an inlet in fluid communication with the sampling flute; and
an outlet in fluid communication with the inlet,
wherein the hood is configured to cause the exhaust gas flow to impact a side of the nitrogen oxide sensor.

10. The system of claim 9, wherein the sampling flute is substantially perpendicular to an axis defined by the exhaust duct and the hood extends in a direction substantially along the axis defined by the exhaust duct.

11. The system of claim 9, wherein the sampling flute and the hood are provided at an end of the exhaust duct away from the SCR catalyst.

12. The system of claim 9, wherein the sampling flute is provided substantially inclined extending across a width of the exhaust duct.

13. The system of claim 9, wherein the nitrogen oxide sensor is configured to be disposed substantially perpendicular to a longitudinal axis defined by the hood.

14. A method of sampling an exhaust gas flow from across an exhaust duct, the method comprising:
providing a passage for an exhaust gas flow within the exhaust duct;
channeling at least a portion of the exhaust gas flowing through the passage into a conduit, the conduit culminating in a hood;
directing the channelized exhaust gas flow across the hood; and
passing the exhaust gas flow outside the hood.

15. The method of claim 14, wherein directing the channelized exhaust gas flow across the hood further includes:
impacting the channelized exhaust gas flow on a side of a nitrogen oxide sensor.

16. The method of claim 14 further comprising:
deflecting at least one of debris and water falling into the passage away from the hood.

17. The method of claim 14 further comprising:
deflecting at least a portion of the exhaust gas flowing through the passage away from the hood.
